(19) United States
(12) Patent Application Publication
(10) Pub. No.: US 2022/0379823 A1
(43) Pub. Date: Dec. 1, 2022

(54) TRACTOR TOOL CADDY

(71) Applicant: David Carruth, Dallas, TX (US)

(72) Inventor: David Carruth, Dallas, TX (US)

(21) Appl. No.: 17/769,735

(22) PCT Filed: Oct. 16, 2020
(86) PCT No.: PCT/US20/56124

§ 371 Date: Apr. 16, 2022

Related U.S. Application Data
(60) Provisional application No. 62/915,950, filed on Oct. 16, 2019.

(51) Int. Cl. B60R 11/06

(52) U.S. Cl. CPC B60R 11/06; B60R 2011/004

(57) ABSTRACT

A storage apparatus suitable for use with farm tractors and similar vehicles. The storage apparatus includes a hollow body mounted to a pair of mounting struts. The mounting struts are shaped and sized to secure to the hitch of the vehicle via mounting holes and fasteners.

### TECHNICAL FIELD OF THE DISCLOSURE

This disclosure relates generally to the field of agriculture, and more specifically to an apparatus for conveniently carrying tools on a farm vehicle.

### SUMMARY OF THE DISCLOSURE

The present disclosure relates to a container for securing tools. In particular, the present disclosure is directed to a tool caddy designed to be secured to the structure of a vehicle, such as a farm tractor, in such a manner as to provide storage capability while preventing interference with the vehicle's functional elements.

In the embodiments disclosed, the tool caddy is secured to the rear hitch of a tractor using threaded fasteners, but those of skill in the art will recognize that the teachings of the present disclosure are applicable in a variety of configurations.

### BRIEF DESCRIPTION OF THE DRAWINGS

For a more complete understanding of the present disclosure, and for further features and advantages, reference is now made to the following description, taken in conjunction with the accompanying drawings, in which:

FIG. 1 is a side view of a farm tractor suitable for use with the present disclosure;

FIG. 2A is a side partial section view of a farm tractor suitable for use with the present disclosure;

FIG. 2B is a rear view of the farm tractor shown in FIG. 2A;

FIG. 2C is a front view of the farm tractor shown in FIGS. 2A and 2B;

FIG. 2D is a bottom view of the farm tractor shown in FIGS. 2A, 2B and 2C;

FIG. 2E is a top view of the farm tractor shown in FIGS. 2A, 2B, 2C and 2D;

FIG. 2F is a three-dimensional view of the back of a farm tractor;

FIG. 2G is a three-dimensional view of the back of the farm tractor shown in FIG. 2F;

FIG. 3A is an isometric view of a tool caddy according to the present disclosure;

FIG. 3B is a rear view of the tool caddy shown in FIG. 3A;

FIG. 3C is a side view of the tool caddy shown in FIGS. 3A and 3B;

FIG. 3D is a bottom view of the tool caddy shown in FIGS. 3A, 3B and 3C;

FIG. 3E is a top view of the tool caddy shown in FIGS. 3A, 3B, 3C and 3D;

FIG. 4A is a three-dimensional view of a tool caddy viewed from the bottom end;

FIG. 4B is an exploded isometric view of the tool caddy shown in FIG. 4A;

FIG. 5A is a top view of a planar strut according to the present disclosure;

FIG. 5B is a side section view of the planar strut of FIG. 5A;

FIG. 5C is a bottom view of the planar strut shown in FIGS. 5A and 5B;

FIG. 5D is an end section view of the planar strut shown in FIGS. 5A, 5B and 5C;

FIG. 6A is a top view of an offset strut according to the present disclosure;

FIG. 6B is a side section view of the offset strut shown in FIG. 6A;

FIG. 6C is a bottom view of the offset strut shown in FIGS. 6A and 6B;

FIG. 6D is a left-end section view of the offset strut shown in FIGS. 6A, 6B and 6C;

FIG. 6E is a right-end section view of the offset strut shown in FIGS. 6A, 6B, 6C and 6D;

FIG. 7A is an isometric view of a planar bracket according to the present disclosure;

FIG. 7B is a top view of the planar bracket of FIG. 7A;

FIG. 7C is a side section view of the planar bracket of FIGS. 7A and 7B;

FIG. 8A is a three-quarters view of a tool caddy having a rectangular cross-sectional shape;

FIG. 8B is a bottom view of the tool caddy of FIG. 8A;

FIG. 9A is a three-quarters view of a tool caddy having a hexagonal cross-sectional shape;

FIG. 9B is a bottom view of the tool caddy of FIG. 9A;

FIG. 10A is a three-quarters view of a tool caddy having an octagonal shape;

FIG. 10B is a bottom view of the tool caddy of FIG. 10A; and

FIG. 11 shows a flowchart showing the process of assembly and use of the tool caddy of the present disclosure.

### DETAILED DESCRIPTION OF THE DRAWINGS

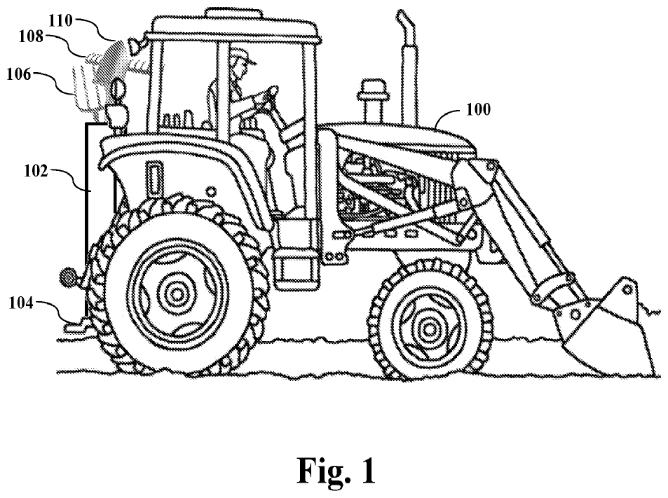

FIG. 1 is a side view of a farm tractor 100 suitable for use with the present disclosure. Farm tractor 100 is a very versatile and useful vehicle, but has limited storage capability. In order to improve the storage capacity of farm tractor 100, a tool caddy 102 has been mounted to the tow hitch 104 at the rear of farm tractor 100. Equipped in this manner, farm tractor 100 is operable to carry large tools such as pitchfork 106, rake 108 and shovel 110. Although this particular tool caddy 102 is mounted vertically to tow hitch 104, those of skill in the art will recognize that tool caddy 102 could potentially be mounted in a different orientation, and could potentially be mounted to a different structure than tow hitch 104. As noted, while the present disclosure is directed to use with a tractor, the present disclosure may be used with a variety of vehicles.

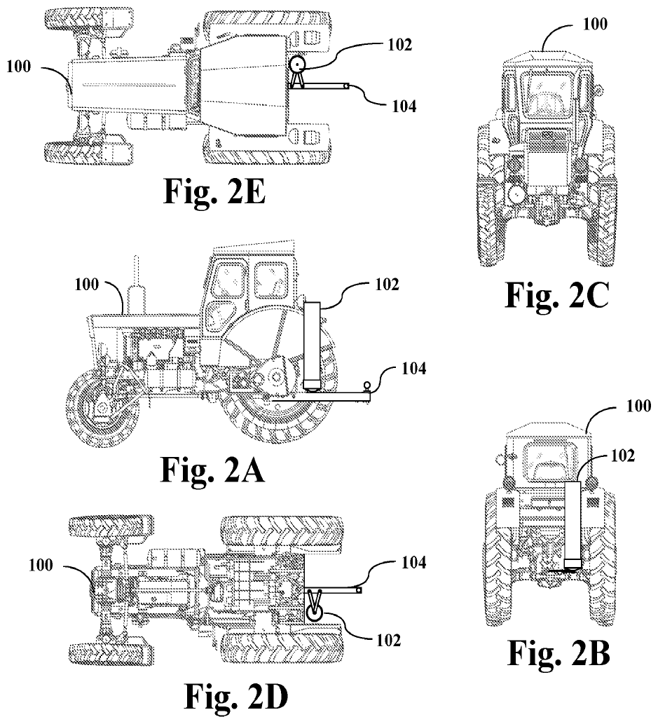

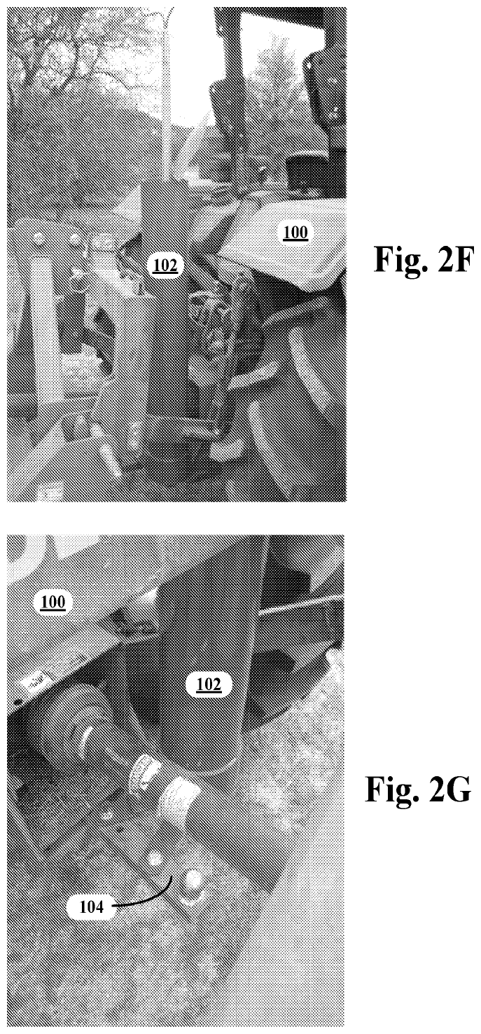

FIG. 2A is a side partial section view of a farm tractor 100 equipped with a tool caddy 102 according to the present disclosure. FIG. 2B is a rear view of farm tractor 100 shown in FIG. 2A. FIG. 2C is a front view of farm tractor 100 shown in FIGS. 2A and 2B. FIG. 2D is a bottom view of farm tractor 100 shown in FIGS. 2A, 2B and 2C. FIG. 2E is a top view of farm tractor 100 shown in FIGS. 2A, 2B, 2C and 2D.

Taken together, FIGS. 2A-2E further elaborate upon the relationship between farm tractor 100, tool caddy 102 and tow hitch 104. As seen in these figures, tool caddy 102 is mounted vertically and to the right of tow hitch 104 viewed from the rear, using a mounting structure which will be described in further detail below. In an alternate embodiment, tool caddy 102 could be mounted to the left of tow hitch 104 using the same or similar mounting structure.

FIG. 2F is a three-dimensional view of the rear portion of farm tractor 100 showing tool caddy 102 mounted in place on tow hitch 104. FIG. 2G is a three-dimensional view of the back of farm tractor 100 and tool caddy 102 of FIG. 2F as viewed from another angle. FIG. 2G in particular provides a clear view of the mounting structure connecting tool caddy 102 to tow hitch 104.

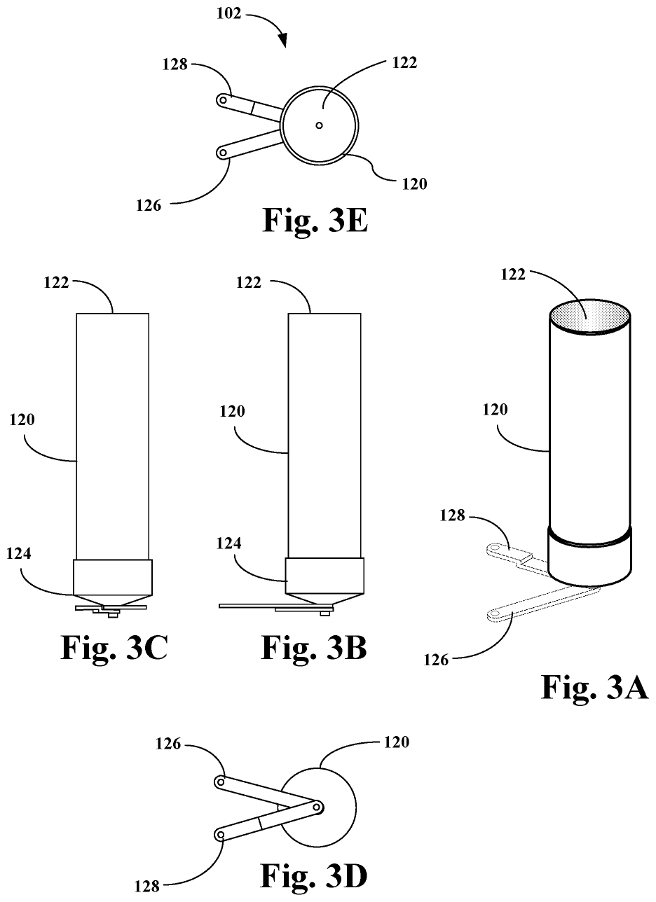

FIG. 3A is an isometric view of tool caddy 102 according to the present disclosure. FIG. 3B is a rear view of tool caddy 102 as shown in FIG. 3A. FIG. 3C is a side view of tool caddy 102 as shown in FIGS. 3A and 3B. FIG. 3D is a bottom view of tool caddy 102 as shown in FIGS. 3A, 3B and 3C. FIG. 3E is a top view of tool caddy 102 as shown in FIGS. 3A, 3B, 3C and 3D.

As seen in FIGS. 3A-3E, tool caddy 102 comprises a hollow, generally-cylindrical main body 120 having an opening 122 at the upper end thereof. The dimensions of the tool caddy may vary by application. In at least one embodiment, tool caddy 102 is approximately 38 inches in height and six inches in diameter. A generally-cylindrical base 124 closes off the bottom end of main body 120. In certain embodiments, main body 120 and base 124 may be formed from a single piece of material. In other embodiments, main body 120 and base 124 may be separate pieces secured to one another by adhesive, a snap-together connection, a spin-on connection or fasteners, as appropriate. A planar strut 126 and an offset strut 128 are secured to the bottom of tool caddy 102 to facilitate the mounting of tool caddy 102 to a structure such as tow hitch 104.

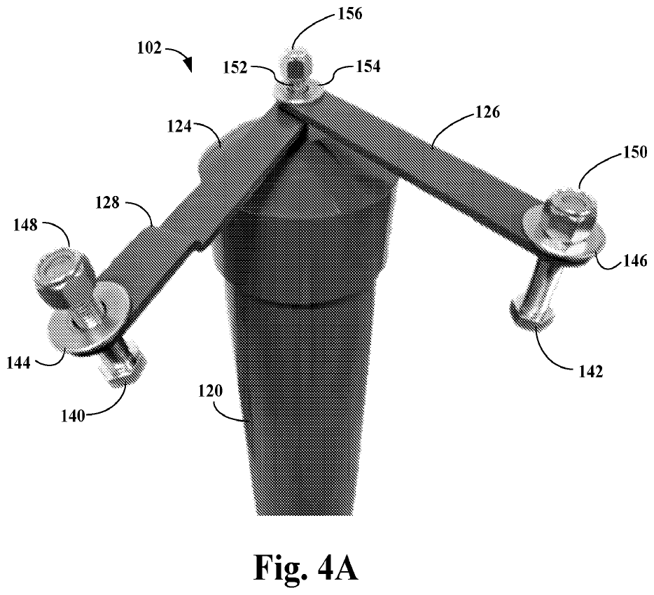

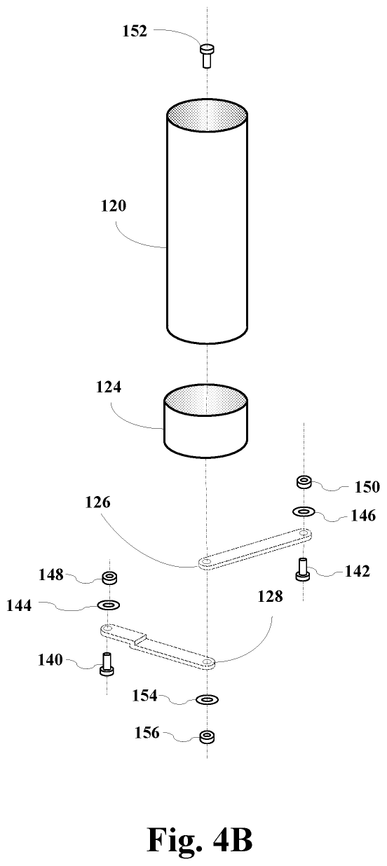

FIG. 4A is a three-dimensional view of tool caddy 102 viewed from the bottom end. FIG. 4B is an exploded isometric view of tool caddy 102. As seen in FIGS. 4A and 4B, the mounting structure for tool caddy 102 comprises struts 126 and 128 secured to the bottom end of tool caddy 102. A set of fasteners is disposed at the outer end of each of struts 126 and 128. Hex bolt 140, in combination with flat washer 144 and nylon insert locknut 148, secures the outer end of offset strut 128. In a similar manner, hex nut 142, in combination with flat washer 146 and nylon insert locknut 150, secures the outer end of planar strut 126. Finally, hex bolt 152, in combination with flat washer 154 and nylon insert locknut 156, secures the inner end of planar strut 126 and inner end of offset strut 128 to cap 124.

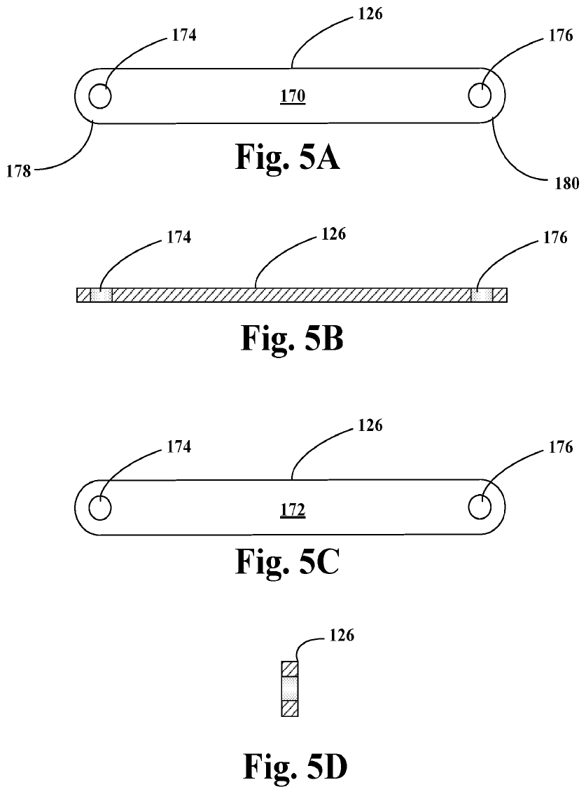

FIG. 5A is a top view of planar strut 126 according to the present disclosure. FIG. 5B is a side section view of planar strut 126. FIG. 5C is a bottom view of planar strut 126. FIG. 5D is an end section view of planar strut 126. Planar strut 126 has an upper surface 170 and a lower surface 172. A first circular aperture 174 is disposed at a first end 178 of planar strut 126. A second circular aperture 176 is disposed at a second end 180 of planar strut 126 opposite the first end. The diameters of circular apertures 174 and 176 may vary by application, but in at least one embodiment, circular apertures 174 and 176 are 5/8 inch in diameter. In the embodiment shown in FIGS. 5A-5C, first and second ends 178 and 180 are radiused, though alternate embodiments may or may not be. The width, length and thickness of planar strut 126 may vary by application. According to one embodiment, planar strut 126 is approximately 11 inches long, 1.5 inches wide and ⅜″ thick.

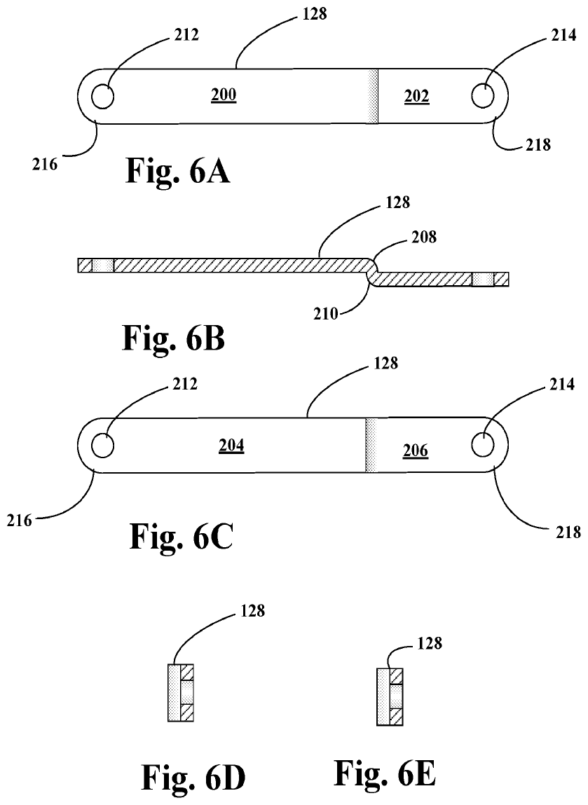

FIG. 6A is a top view of offset strut 128 according to the present disclosure. FIG. 6B is a side section view of offset strut 128. FIG. 6C is a bottom view of offset strut 128. FIG. 6D is a left-end section view of offset strut 128. FIG. 6E is a right-end section view of offset strut 128. Offset strut 128 has a first upper surface 200, a second upper surface 202, a first lower surface 204 and a second lower surface 206. As can be seen in FIGS. 6A-6E, surfaces 202 and 206 are offset from, but generally parallel to, surfaces 200 and 204. First bend 208 and second bend 210 create an offset in offset strut 128.

A first circular aperture 212 is disposed at a first end 216 of offset strut 128. A second circular aperture 214 is disposed at a second end 218 of offset strut 128. The diameters of circular apertures 212 and 214 may vary by application, but in at least one embodiment, circular apertures 212 and 214 are ⅝ inch in diameter. In the embodiment shown in FIGS. 6A-6E, first and second ends 216 and 218 are radiused, though alternate embodiments may or may not be. The width, length and thickness of offset strut 128 may vary by application. According to one embodiment, planar strut 126 is approximately 11 inches long, 1.5 inches wide and ⅜ inch thick. In one application, offset surfaces 202 and 206 are offset by approximately ⅜ inch, and the location of bends 208 and 210 is approximately 4 inches from second end 218.

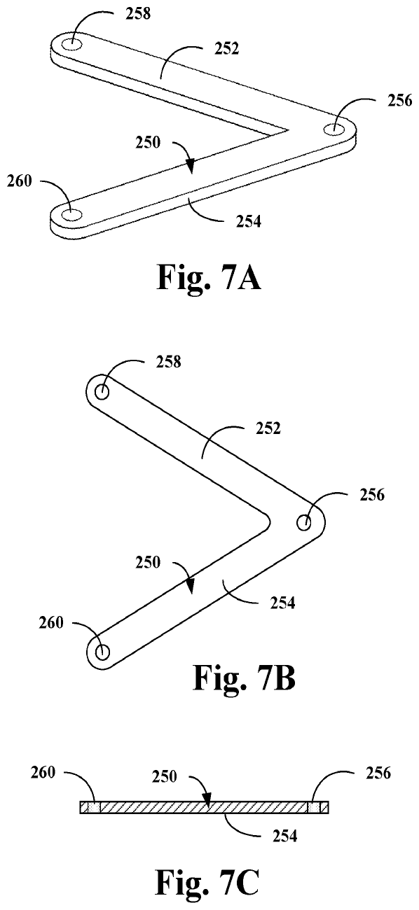

FIG. 7A is an isometric view of a planar bracket 250 according to the present disclosure. FIG. 7B is a top view of planar bracket 250. FIG. 7C is a side section view of planar bracket 250. Planar bracket 250 may be suitable as a support for tool caddy 102 in certain specific applications, as a one-piece substitute for struts 126, 128.

Planar bracket 250 comprises first leg 252 and second leg 254. Central mounting hole 256 is disposed at the junction of first leg 252 and second leg 254. A first distal mounting hole 258 is disposed at the distal end of first leg 252. A second distal mounting hole 260 is disposed at the distal end of second leg 254.

Although the tool caddy of the present disclosure has been described in connection with mounting brackets or struts, those of skill in the art will recognize that the tool caddy of the present invention may be used without such structures, and may in certain applications be secured directly to a vehicle. As an example, the tool caddy may be bolted directly to a floorboard, to the bed of a truck, or to some other structure.

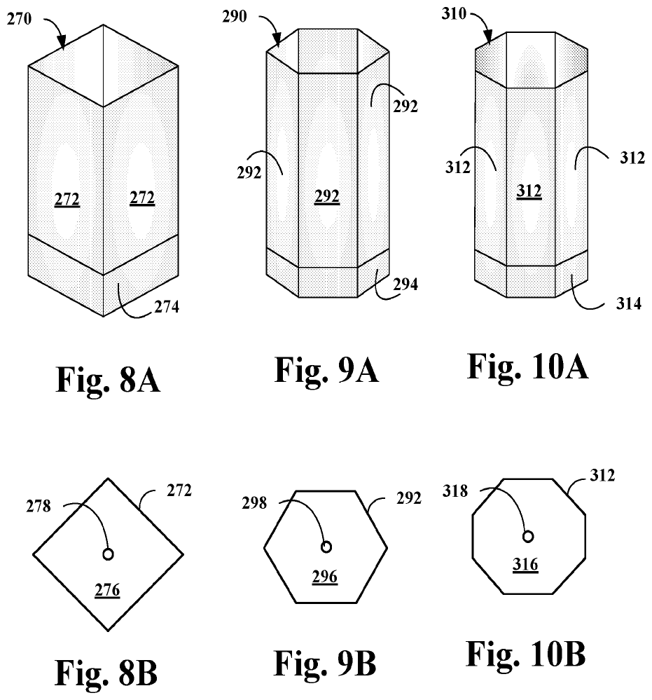

The tool caddy of the present disclosure has been described above as having a cylindrical shape, but those of skill in the art will appreciate that alternate embodiments may have alternate geometries. As an example, FIG. 8A is a three-quarters view of a tool caddy 270 having a rectangular cross-sectional shape. FIG. 8B is a bottom view of tool caddy 270. Tool Caddy 270 has a generally-rectangular shape with four sides 272 and a base 274. Base 274 has a bottom surface 276 with a cylindrical hole 278 in the center thereof for securement via bolt 152.

As another example, FIG. 9A is a three-quarters view of a tool caddy 290 having a hexagonal cross-sectional shape. FIG. 9B is a bottom view of tool caddy 290. Tool caddy 290 has a generally-hexagonal shape with six sides 292 and a base 294. Base 294 has a bottom surface 296 with a cylindrical hole 298 in the center thereof for securement via bolt 152.

To provide yet another example, FIG. 10A is a three-quarters view of a tool caddy 310 having an octagonal cross-sectional shape. FIG. 10B is a bottom view of tool caddy 310. Tool caddy 310 has a generally-octagonal shape with eight sides 312 and a base 314. Base 314 has a bottom surface 316 with a cylindrical hole 318 in the center thereof for securement via bolt 152. Those of skill in the art will recognize that tool caddies 270, 290, 310 are provided only by way of example, and that alternate embodiments may have a variety of shapes without departing from the spirit and scope of the present disclosure.

FIG. 11 shows a flowchart showing the process of assembly and use of the tool caddy of the present disclosure. In order to assemble the caddy, the caddy base is secured to the caddy body (350). A first fastener is then inserted to the mounting hole of the caddy base (352), then to the first mounting hole of the first mounting strut (354) and the first mounting hole of the second mounting strut (356), then tightened, to secure the caddy base and body to the first and second mounting struts.

After the caddy base and body are secured to the first and second mounting struts by the first fastener, the mounting holes in the outboard ends of the first and second mounting struts are aligned to mounting holes in the tractor hitch (360). Second and third fasteners are then inserted into the outboard mounting holes of the first and second mounting struts and the mounting holes of the tractor hitch (362). The second and third fasteners are then tightened, to secure the first and second mounting struts, and thus the caddy base and body, to the tractor hitch (364). With the caddy base and body secured to the tractor hitch in this manner, contents including but not limited to tools may be stored within the caddy body.

The disclosure has been described above in connection with certain specific embodiments of the inventive concepts. It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An apparatus for storing tools comprising:
a base having a bottom surface and an upper portion, the bottom surface having a mounting hole disposed therein;
a hollow body, secured to the upper portion of the base;
a first mounting strut having a first mounting hole in a first end thereof aligned to the mounting hole of the base and a second mounting hole in a second end thereof;
a second mounting strut having a first mounting hole in a first end thereof aligned to the mounting hole of the base and a second hole in a second end thereof; and
a fastener, disposed in the mounting hole of the base, the first hole of the first mounting strut and the first hole of the second mounting strut in such manner as to secure the first and second mounting struts to the base.

2. The apparatus of claim 1 wherein the hollow body has a generally-cylindrical shape.

3. The apparatus of claim 1 wherein the hollow body has a generally-rectangular shape.

4. The apparatus of claim 1 wherein the hollow body has a polygonal shape.

5. The apparatus of claim 1 wherein the first fastener comprises a bolt and nut.

6. The apparatus of claim 5 wherein the nut is a locknut.

7. The apparatus of claim 5 further comprising flat washers.

8. The apparatus of claim 1 wherein the hollow body is composed of a polymer.

9. The apparatus of claim 1 wherein the hollow body is metal.

10. A method of storing tools, comprising:
providing a base having a bottom surface and an upper portion, the bottom surface having a mounting hole disposed therein;
securing the upper portion of the base to a hollow body;
providing a first mounting strut having a first mounting hole in a first end thereof and a second mounting hole in a second end thereof;
providing a second mounting strut having a first mounting hole in a first end thereof and a second hole in a second end thereof;
securing the first end of the first mounting strut and the first end of the second mounting strut to the base using a first fastener;
securing the second end of the first mounting strut to a tractor hitch using a second fastener;
securing the second end of the second mounting strut to a tractor hitch using a third fastener; and
disposing tools in the hollow body.

11. The method of claim 10 wherein the hollow body has a generally-cylindrical shape.

12. The method of claim 10 wherein the hollow body has a generally-rectangular shape.

13. The method of claim 10 wherein the hollow body has a polygonal shape.

14. The method of claim 10 wherein the first fastener comprises a bolt and nut.

15. The method of claim 14 wherein the nut is a locknut.

16. The method of claim 14 wherein the fastener further comprises flat washers.

17. The method of claim 10 wherein the hollow body is composed of a polymer.

18. The method of claim 10 wherein the hollow body is metal.
